(19) United States
(12) Patent Application Publication
(10) Pub. No.: US 2017/0022296 A1
(43) Pub. Date: Jan. 26, 2017

(54) METHOD FOR PRODUCING DIENE POLYMERS BEARING PHOSPHORUS FUNCTIONAL GROUPS, PRODUCTS RESULTING FROM SAID METHOD AND COMPOSITION CONTAINING SAME

(71) Applicants: COMPAGNIE GENERALE DES ETABLISSEMENTS MICHELIN, Clermont-Ferrand (FR); MICHELIN RECHERCHE ET TECHNIQUE S.A., Granges-paccot (CH); CENTRE NATIONAL DE LA RECHERCHE SCIENTIFIQUE, Paris Cedex 16 (FR); UNIVERSITÉ PAUL SABATIER, Toulouse Cedex 9 (FR)

(72) Inventors: Charlotte DIRE, Clermont-Ferrand (FR); Rachid MATMOUR, Clermont-Ferrand (FR); Issam BLIDI, El Alia (TN); Olivier COUTELIER, Auzeville-Tolosane (FR); Mathias DESTARAC, Toulouse (FR)

(73) Assignees: Compagnie Generale des Etablissements Michelin, Clermont-Ferrand (FR); Michelin Recherche et Technique S.A., Granges-Paccot (CH)

(21) Appl. No.: 15/118,035

(22) PCT Filed: Feb. 10, 2015
(86) PCT No.: PCT/EP2015/052702

§ 371 Date: Aug. 10, 2016

(30) Foreign Application Priority Data
Feb. 11, 2014 (FR) 1451037

(51) Int. Cl. C08C 19/24; C08K 5/00; C08K 3/00

(52) U.S. Cl. CPC C08C 19/24; C08K 3/0033; C08K 5/0008

(57) ABSTRACT

The invention relates to a method for the synthesis of a novel diene polymer with a high content of phosphorus-based functions by radical grafting of a polyphosphorus-based polymer bearing a chain-end thiol function onto a diene polymer according to the following steps:
a) bringing together, with stirring, at least one diene polymer in solution and at least one polyphosphorus-based polymer bearing a chain-end thiol function in solution,
b) heating the homogeneous reaction mixture obtained in the previous step to the grafting reaction temperature, and
c) adding the radical initiator concomitantly with either of steps a) and b) or once the grafting reaction temperature has been reached.

This application is a 371 national phase entry of PCT/EP2015/052702, filed 10 Feb. 2015, which claims benefit of French Patent Application No. 1451037, filed 11 Feb. 2014, the entire contents of which are incorporated herein by reference for all purposes.

### BACKGROUND

1. Technical Field

The present invention relates to diene polymers, especially elastomeric diene polymers, bearing pendant phosphonate and/or phosphonic functions along the chain, and also to the method for preparation thereof. The present invention also relates to rubber compositions containing diene elastomers bearing phosphonate and/or phosphonic functions, with a view especially to an application in vehicle tyres.

2. Related Art

In order to modify the properties of synthetic elastomers contained in rubber compositions for tyres, various strategies are possible. Among these, the introduction of novel chemical functions at the polymer chain end or along the polymer chain is one of the methods used.

The applicants are particularly concerned, within the context of the invention, with functionalization along the diene polymer chain. Various types of reactions on the unsaturations of diene polymers which make functionalization possible are known from the literature. Mention may be made of [4+2] cycloaddition reactions, of Diels-Alder reaction type, between a dienophile (maleic anhydride for example) and diene copolymers having conjugated dienes along the chain by virtue of the insertion of a conjugated triene comonomer (alloocimene) during the anionic copolymerization (EP2423239A1).

Mention may also be made of hydrosilylation reactions of a hydrosilane bearing a function (epoxide for example) on the pendant unsaturations of a diene polymer (FR 13/62946).

1,3-dipolar cycloaddition reactions in the presence of nitrile oxide or nitrone (R. Huisgen, Angew. Chem. Int. Ed. 1963, 2, 565-632; R. Huisgen, Angew. Chem. Int. Ed. 1963, 2, 633-645; J. J. Tufariello, In 1,3-Dipolar Cycloaddition Chemistry, Padwa, A. Ed., Wiley—Interscience: New York, 1984, Chapter 9, p. 83; K. B. G. Torssell, Nitrile Oxides, Nitrones, and Nitronates, VCH Publishers Inc.: New York 1988; K. V. Gothelf, K. V. Jorgensen, Chem. Rev. 1988, 98, 863-909) are also known for the functionalization (WO2012007441A1, WO2006045088A2) or the crosslinking of diene polymer (FR1583406, WO2006081415A2).

Radical grafting of functional or non-functional thiols via photochemical or chemical catalyses (with or without radical initiator) belongs to these reactions for the functionalization of diene polymers (natural and synthetic rubber) in the same way as the cycloaddition or hydrosilylation reactions mentioned above (Angew. Chem. Int. Ed. 2010, 49, 1540-1573; J. Polym. Sci.: Part A: Polym. Chem. 2004, 42, 5301-5338; Polym. Chem., 2010, 1, 17-36; FR 13/62946).

The applicants are more particularly concerned, within the context of the invention, with obtaining a diene polymer bearing phosphonate and/or phosphonic functions along the chain.

Indeed, phosphorus-based polymers have recently begun to attract growing interest due to their usefulness in a wide range of applications, such as for example fuel cells (J. Fuel Cells, 2005. 5, (3), 355), electrolyte membranes (cation exchange membranes) (J. App. Poly. Sci. 1999, 74, 83), flame retardants (Macromolecules, 1998, 31, 1010; Rhodia Chimie WO 2003076531), additives for dental cements (J. Dent. Res, 1974, 53, (4), 867), biomaterials (orthopaedic applications) (J. Mater. Sci. Lett. 1990, 9, 1058; Macromol. Rapid Commun. 2006, 20, 1719-24), solubilization of medication (hydrogels for medication release) (J. Appl. Polym. Sci. 1998, 70, 1947), cell proliferation promoters (Fuji Photo Film Co, U.S. Pat. No. 6,218,075; Biomaterials, 2005, 26, 3663-3671) and corrosion-inhibiting agents in cooling systems (Macromolecules, 1998, 31, 1010).

The phosphonate or phosphonic function of these polymers may either be present in a monomer involved in the copolymerization with the other constituent monomer(s) of the polymer, or may be obtained by post-polymerization modification of the polymer.

One of the modes for synthesizing phosphorus-based diene polymer known to those skilled in the art is chemical post-polymerization modification of diene polymer by radical grafting of functionalized thiols bearing a phosphorus-based function. The group of Prof. Boutevin (Polym. Bull. 1998, 41, 145-151) describes radical grafting of a thiol, diethyl (3-mercaptopropyl)phosphonate (HS—(CH₂)₃—PO₃(Et)₂), onto a hydroxytelechelic polybutadiene (Mₙ=1200 g/mol and with 20% or 80% of 1,2-butadiene units) in THF with azobisisobutyronitrile (AIBN) as radical initiator, at 70° C. for 6 hours.

To truly benefit from the reactivity of the phosphonate and/or phosphonic functions of a diene polymer comprising them, with a view to significantly modifying the properties of the polymer in its most wide-ranging applications, it is necessary to use a polymer having high contents of phosphonate and/or phosphonic functions.

In light of the existing methods of post-polymerization modification by radical grafting, increasing the content of functions on the polymer involves using a larger proportion of functionalized thiols bearing a phosphorus-based function.

However, the use of functionalized thiol molecules bearing a phosphorus-based function to achieve high contents of grafted functions leads to a significant change in the macrostructure of the resulting modified polymer. This change in macrostructure observed in the context of radical grafting is generally due to side reactions (radical-radical bimolecular coupling, transfer reactions, etc.), the proportion of these side reactions increasing with the targeted molar content of grafted functions.

### SUMMARY

The technical problem posed by the prior art is that of having a simple and reproducible method which makes it possible to synthesize a polymer having a high molar content of phosphonate and/or phosphonic functions while overcoming the drawbacks linked to the use of high proportions of thiol molecules bearing a phosphorus-based function.

The present invention responds to this technical problem in that the inventors have developed, through their research, a novel method for preparing diene polymers having a high molar content of phosphonate and/or phosphonic functions along the chain, while significantly limiting the change in macrostructure of the polymer linked to the grafting of high proportions of functions. Indeed, the inventors have developed a method for preparing diene polymers bearing polyphosphorus-based grafts.

A first subject of the invention is therefore a method for the synthesis of diene polymers bearing polyphosphorus-based grafts by radical grafting of a polyphosphorus-based polymer bearing a chain-end thiol function onto a diene polymer according to the following steps:
a. bringing together, with stirring, at least one diene polymer and at least one polyphosphorus-based compound bearing a chain-end thiol function, each being dissolved in a solvent,
b. heating the homogeneous reaction mixture obtained in the previous step to the grafting reaction temperature, and
c. adding the radical initiator concomitantly with either of steps a) and b) or once the grafting reaction temperature has been reached.

Another subject of the invention is a diene polymer bearing polyphosphorus-based grafts, which polymer is able to be obtained by the method in accordance with the invention.

Another subject of the invention is a reinforced rubber composition based on at least one reinforcing filler and on a diene elastomer bearing polyphosphorus-based grafts.

Another subject of the invention is a tyre, one of the constituent elements of which comprises a rubber composition in accordance with the invention.

In the present description, “graft” is intended to mean the polyphosphorus-based polymer chain attached to the polymer backbone.

### DETAILED DESCRIPTION OF EXAMPLE EMBODIMENTS

In the present description, “polyphosphorus-based polymer” is intended to mean a polymer which bears several phosphorus-based functions.

In the present description, the term “phosphorus-based” is intended to mean, whether in relation to the function or to the polymer, that a group or a polymeric unit, depending on the case in question, comprises at least one phosphonate function, phosphonic hemiacid function or phosphonic diacid function. The term “a phosphonic function” is used to refer to a phosphonic hemiacid function or a phosphonic diacid function.

In the present description, “unit” of a polymer is intended to mean any unit derived from a monomer of the polymer backbone in question.

In the present description, the expression “thiol-terminated” is intended to mean, in reference to the polyphosphorus-based polymer, that it bears a thiol function at a chain end.

In the present description, molar content or molar percentage of a unit in a polymer is used to define the number of moles of these units in the polymer relative to the total number of moles of units present in said polymer. Moreover, molar content or molar percentage of a graft in a polymer, or else degree of grafting, is used to define the number of moles of graft in the polymer relative to the total number of moles of diene units present in said starting polymer.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

“Grafting yield” is intended to mean the amount of thiol derivative grafted relative to the amount of thiol introduced.

Thus, a subject of the invention is a method for the synthesis of a polymer of diene polymers bearing polyphosphorus-based grafts, thus with a high content of phosphorus-based functions, by radical grafting of a polyphosphorus-based polymer bearing a chain-end thiol function onto a diene polymer.

According to the invention, the polyphosphorus-based polymer bearing a chain-end thiol function may be represented by the formula R—P—SH, with R representing an alkyl, acyl, aryl, alkenyl or alkynyl group, a saturated or unsaturated, optionally aromatic carbon-based ring, a saturated or unsaturated, optionally aromatic heterocycle, or a polymer chain, and with P representing the polyphosphorus-based chain.

By way of polyphosphorus-based polymer bearing a chain-end thiol function, mention may be made, according to some variants of the invention, of the compounds of general formula I:

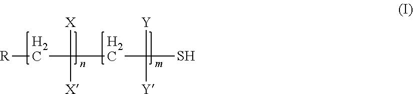

with
m denoting an integer greater than or equal to 1 and n denoting an integer greater than or equal to 0_{;} with the proviso that, when n is other than 0, n and m may be identical or different, preferably each greater than 2 and preferably less than 500,
R representing:
   (i) an alkyl, acyl, aryl, alkenyl or alkynyl group;
   (ii) a saturated or unsaturated, optionally aromatic carbon-based ring of groups (i);
   (iii) a saturated or unsaturated, optionally aromatic heterocycle;
   these groups and rings (i), (ii) and (iii) being able to be substituted by substituted phenyl groups, substituted aromatic groups, or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R′ representing an alkyl or aryl group;
   (iv) a polymer chain;
X and X′, which are identical or different, representing a hydrogen atom, a halogen or an R₁, OR₁, OCOR₁, NHCOH, NHCOH, OH, NH₂, NHR₁, N(R₁)₂, (R₁)₂N⁺O⁻, NHCOR₁, CO₂H, CO₂R₁, CN, CONH₂, CONHR₁ or CON(R₁)₂ group, in which groups R₁ is selected from alkyl, aryl, aralkyl, alkylaryl, alkene or organosilyl groups which are optionally perfluorinated and optionally substituted by one or more carboxyl, epoxy, hydroxyl, alkoxy, amino, halogen or sulphonic groups;
Y and Y′, which are identical or different, being such that either Y or Y′, or both, comprise at least one phosphorus-based —P(O)(OR₂)(OR₃) function, in which R₂ and R₃, which are identical or different, represent a hydrogen atom or an alkyl, optionally haloalkyl, radical.

According to the invention, the term “alkyl” denotes a linear or branched hydrocarbon-based radical with 1 to 20 carbon atoms, such as methyl, ethyl, propyl, isopropyl, butyl, tert-butyl, isobutyl, pentyl, hexyl, heptyl, octyl, nonyl, decyl, undecyl, dodecyl, tridecyl, tetradecyl, pentadecyl, hexadecyl, heptadecyl, octadecyl, nonadecyl or icosyl.

“Alkenyl” is intended to mean a linear or branched hydrocarbon-based chain having from 2 to 20 carbon atoms, comprising one or more double bonds. Examples of particularly preferred alkenyl groups are the alkenyl groups bearing just one double bond, such as —CH₂—CH₂—CH═C(CH₃)₂, vinyl or allyl.

“Alkynyl” is intended to mean a linear or branched hydrocarbon-based chain having from 2 to 20 carbon atoms, comprising one or more triple bonds. Examples of particularly preferred alkynyl groups are the alkynyl groups bearing just one triple bond, such as —CH₂—CH₂—C≡CH.

“Cycloalkyl” is intended to mean saturated hydrocarbon-based groups which may be monocyclic or polycyclic and comprise from 3 to 12 carbon atoms, preferably from 3 to 8, The monocyclic cycloalkyl groups such as cyclopropyl, cyclobutyl, cyclopentyl, cyclohexyl, cycloheptyl, cyclooctyl, cyclononyl, cyclodecyl, cycloundecyl and cyclododecyl are more particularly preferred.

“Cycloalkenyl” is intended to mean, according to the invention, a group derived from a cycloalkyl group as defined above, having one or more double bonds, preferably one double bond.

“Cycloalkynyl” is intended to mean, according to the invention, a group derived from a cycloalkyl group as defined above, having one or more triple bonds, preferably one triple bond.

“Aryl” is intended to mean a monocyclic or bicyclic aromatic hydrocarbon-based in group comprising 6 to 10 carbon atoms, such as phenyl or naphthyl.

“Alkaryl” is intended to mean an alkyl group as defined above, substituted by an aryl group.

“Aralkyl” is intended to mean an alkyl group as defined above, substituted by an aryl group.

“Alkoxy” is intended to mean an 0-alkyl group generally having from 1 to 20 carbon atoms, especially methoxy, ethoxy, propoxy and butoxy.

The heterocyclic group (iii) denotes saturated, or preferably unsaturated, monocyclic or bicyclic 5- to 12-membered carbon-based rings having 1, 2 or 3 endocyclic heteroatoms selected from O, N and S. These are generally derivatives of the heteroaryl groups. Generally, “heteroaryl” is intended to mean 5- to 7-membered monocyclic aromatic groups or 6- to 12-membered bicyclic aromatic groups comprising one, two or three endocyclic heteroatoms selected from O, N and S. Examples thereof are furyl, thienyl, pyrrolyl, oxazolyl, isoxazolyl, thiazolyl, isothiazolyl, imidazolyl, pyrazolyl, oxadiazolyl, triazolyl, thiadiazolyl, pyridyl, pyridazinyl, pyrazinyl and triazinyl groups. Preferably, when it is unsaturated the heterocycle comprises just one double bond. Preferred examples of unsaturated heterocycles are dihydrofuryl, dihydrothienyl, dihydropyrrolyl, pyrrolinyl, oxazolinyl, thiazolinyl, imidazolinyl, pyrazolinyl, isoxazolinyl, isothiazolinyl, oxadiazolinyl, pyranyl and the monounsaturated derivatives of piperidine, dioxane, piperazine, trithiane, morpholine, dithiane or thiomorpholine, and also tetrahydropyridazinyl, tetrahydropyrimidinyl, and tetrahydrotriazinyl.

According to variants of the invention, R is as defined in the documents WO 98/58974, WO 00/75207 and WO 01/42312 (definition of R₁), WO 98/01478 and WO 99/31144 (definition of R), or WO 02/26836 (definition of R₁).

Among these variants, R is more particularly a CNCH₂— cyanomethyl group, CH₃(C₆H₅)CH— 1-phenylethyl group or CH₃(CO₂CH₃)CH— methylpropionyl group.

The molar fraction of monomer units of the polyphosphorus-based polymer comprising X and X′ may be zero, and generally ranges from 0 to 0.5, preferably in from 0 to 0,25, better still from 0 to 0.1.

Among the monomers from which the units bearing phosphorus-based functions in Y and Y′ which may be used in the present invention are derived, mention may especially be made of vinylphosphonic acid, vinylphosphonic acid dimethyl ester, vinylphosphonic acid bis(2-chloroethyl) ester, vinylidenediphosphonic acid, vinylidenediphosphonic acid tetraisopropyl ester, alpha-styrenephosphonic acid, dimethyl-p-vinylbenzylphosphonate, diethyl-p-vinylbenzylphosphonate, dimethyl(methacryloyloxy)methyl phosphonate, diethyl(methacryloyloxy)methyl phosphonate, diethyl 2-(acrylamido)ethylphosphonate, and more generally any unsaturated styrene, acrylate or methacrylate, acrylamido or methacrylamido, vinyl or allyl monomer bearing at least one dialkylphosphonate, phosphonic diacid or hemiacid —P(OH)(OR) group, or a mixture of these monomers. Preferably, vinylphosphonic acid dimethyl ester and dimethyl-p-vinylbenzylphosphonate will be used.

Since the polymer bearing a thiol function is polyphosphorus-based, it is of course understood that when m is equal to 1, the —CH₂—CYY′— unit comprises more than one phosphorus-based —P(O)(OR₂)(OR₃) function.

Among the comonomers from which the units substituted by X and X′ which may be used in the present invention are derived, mention may be made of the hydrophilic (h) or hydrophobic (H) monomers selected from the following monomers.

Among the hydrophilic monomers (h), mention may be made of:
vinyl alcohol resulting from the hydrolysis of vinyl acetate, for example.
neutral acrylamido monomers such as acrylamide, N,N-dimethylacrylamide and N-isopropylacrylamide.
cyclic amides of vinylamine, such as N-vinylpyrrolidone and vinylcaprolactam.
ethylenic unsaturated monocarboxylic and dicarboxylic acids such as acrylic acid, methacrylic acid, itaconic acid, maleic acid or fumaric acid.
ethylenic monomers comprising a sulphonic acid group or one of the alkali metal salts or ammonium salts thereof, such as for example vinylsulphonic acid, vinylbenzenesulphonic acid, alpha-acrylamidomethylpropanesulphonic acid or 2-sulphoethyl methacrylate, or
monomers selected from aminoalkyl (meth)acrylates, aminoalkyl (meth)acrylamides, monomers comprising at least one secondary, tertiary or quaternary amine function, diallyl dialkyl ammonium salts such as dimethylaminoethyl (meth)acrylate, dimethylaminopropyl (meth)acrylate, dimethylaminopropyl (meth)acrylamide, 2-vinylpyridine, 4-vinylpyridine and diallyldimethyl ammonium chloride.

Preferably, the hydrophilic (h) monomer units are selected from acrylic acid (AA), dimethylaminopropyl acrylamide and N-vinyipyrrolidone.

Among the hydrophobic monomers (H), mention may be made of:
styrene-derived monomers such as styrene, alpha-methylstyrene, para-methylstyrene or para-tert-butylstyrene, or
optionally fluorinated esters of acrylic acid or methacrylic acid with C₁-C₁₂, preferably C₁-C₆, alcohols such as for example methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate,
vinyl nitriles containing from 3 to 12 carbon atoms, especially acrylonitrile or methacrylonitrile,
vinyl esters of carboxylic acids, such as vinyl acetate (VAc), vinyl versatate or vinyl propionate,
vinyl halides or vinylidene halides, for example vinyl chloride, vinylidene chloride and vinylidene fluoride, and
diene monomers, for example butadiene or isoprene.

Preferably, the hydrophobic monomer units (H) of the copolymers of the invention are butadiene, isoprene, butyl acrylate and styrene.

The thiol-functional polyphosphorus-based polymer as defined above has a mean number of units at least equal to 2 and at most equal to 1000.

The chain-end thiol-functional polyphosphorus-based polymer may be any homopolymer obtained by polymerization of a monomer bearing at least one phosphorus-based function or any copolymer of one or more monomers bearing at least one phosphorus-based function, with one another or with one or more comonomers.

According to variants of the invention, the chain-end thiol-functional polyphosphorus-based polymer may be obtained by RAFT- or MADIX-controlled radical (co)polymerization of at least one monomer bearing at least one phosphorus-based function in the presence of a source of free radicals and a thiocarbonylthio chain transfer agent of general formula (II):

R—S(C═S)—Z (II)
in which:
R represents:
   (i) an alkyl, acyl, aryl, alkenyl or alkynyl group;
   (ii) a saturated or unsaturated, optionally aromatic carbon-based ring;
   (iii) a saturated or unsaturated, optionally aromatic heterocycle;
   these groups and rings (i), (ii) and (iii) being able to be substituted by substituted phenyl groups, substituted aromatic groups, or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R representing an alkyl or aryl group;
   (iv) a polymer chain;
Z is an oxygen atom, a carbon atom, a sulphur atom, a nitrogen atom or a phosphorus atom, these atoms being substituted by one, two or three hydrocarbon-based radicals R″ so as to have the appropriate valency, possibly comprising at least one heteroatom, such that R″ represents a group as defined above for R.

According to variants of the invention, R and R″ are as defined in documents WO 98/58974, WO 00/75207 and WO 01/42312 (definition of R₁ or R₂), WO 98/01478 and WO 99/31144 (definition of R or Z and Ei), or WO 02/26836 (definition of R₁ or the nitrogen-based group).

According to variants of the invention, in general formula (II), R is more particularly a CNCH₂— cyanomethyl group, CH₃(C₆H₅)CH— 1-phenylethyl group or CH₃(CO₂CH₃)CH— methylpropionyl group.

According to variants of the invention, in general formula (II), Z denotes an OR″ group with R″ denoting a C₁-C₅, more preferentially still C₁-C₂alkyl radical.

Thus, according to variants of the invention, the polyphosphorus-based polymers of formula I may be obtained by RAFT or MADIX polymerization of the monomers comprising Y and Y′ and, where appropriate, the monomers comprising X and X′, especially those listed above, in the form of homopolymers (where n=0), or random or block copolymers.

The preferential aspects and variants above may be combined with one another.

A thiocarbonylthio transfer agent corresponding to general formula (II) may be synthesized in a way known to those skilled in the art.

The RAFT or MADIX polymerization initiator may be selected from the initiators conventionally used in radical polymerization.

Transfer agents or methods which may be used for carrying out the synthesis of the polyphosphorus-based polymer bearing a thiol function are especially described in the following documents:
the methods and agents of applications WO 98/58974, WO 00/75207 and WO 01/42312, which use a radical polymerization controlled by control agents of xanthate type (—S—(C═S)—O— group),
the method and the agents of radical polymerization controlled by control agents of dithioester type (—S—(C═S)—S—C group) or trithiocarbonate type (—S—(C═S)—S— group) of application WO 98/01478,
the method and the agents of radical polymerization controlled by control agents of dithiocarbamate type (—S—(C═S)—N group) of application WO 99/31144,
the method and the agents of radical polymerization controlled by control agents of dithiocarbazate type (—S—(C═S)—N group) of application WO 02/26836,
agents of xanthate, dithiocarbonate and/or trithiocarbonate type described in documents WO 02070571; WO 2001060792; WO 2004037780; WO 2004083169; WO 2003066685; WO 2005068419; WO 2003062280; WO 2003055919 and WO 2006023790, and the methods using them.

One of the advantages of the RAFT or MADIX polymerization method is the possibility of controlling the polyphosphorus-based polymer length by adjusting the molar ratio of the monomer and of the transfer agent. The molar ratio of the monomer to the transfer agent is generally at least 2. According to variants of the invention linked to the choice of phosphorus-based monomer, this ratio is at most 1000.

At the end of polymerization, the product is predominantly of general formula R—P—S—(C═S)—Z, P denoting the polyphosphorus-based polymer chain.

The thiol derivative R—P—SH is obtained by chemical modification of this thiocarbonylthio-terminated product. Among the methods envisaged, mention will advantageously be made of the aminolysis reaction, generally carried out with primary or secondary amine compounds. Even more advantageously, the thiol-terminated polyphosphorus-based polymer R—P—SH is formed directly by thermolysis of specific thiocarbonylthio groups, for example xanthates derived from secondary alcohol.

The method for the synthesis of a polymer with a high content of phosphonate and/or phosphonic functions by radical grafting of a polyphosphorus-based polymer onto a diene polymer according to the invention consists in grafting polyphosphorus-based polymers bearing a chain-end thiol function as defined above for grafting onto the unsaturations of the diene polymer.

“Diene polymer” is intended to mean, according to the invention, any polymer, in the sense in which they are known to those skilled in the art, resulting at least in part (i.e., a homopolymer or a copolymer) from diene monomers (monomers bearing two conjugated or non-conjugated carbon-carbon double bonds).

According to the invention, the diene polymers may be classified into two categories: “essentially unsaturated” or “essentially saturated”. “Essentially unsaturated” is intended to mean a diene polymer resulting at least in part from conjugated diene monomers having a content of units of diene origin (conjugated dienes) which is greater than 15% (mol %). This category of “essentially unsaturated”, especially elastomeric, diene polymers is more particularly addressed by the method according to the invention. In the category of “essentially unsaturated” diene elastomers, “highly unsaturated” diene elastomer is intended to mean in particular a diene elastomer having a content of units of diene origin (conjugated dienes) which is greater than 50%/(mol %). “Essentially saturated” is intended to mean a diene elastomer having a content of saturated units which is greater than 20% (mol %). The saturated units may be units with an equivalent structure to that obtained from an olefinic monomer. In the category of “essentially saturated” diene elastomers, “highly saturated” diene elastomer is intended to mean in particular a diene elastomer having a content of saturated units which is greater than 50% (mol %).

“Diene elastomer able to be used in the invention” is more particularly intended to mean:

(a) any homopolymer obtained by polymerization of a conjugated diene monomer having from 4 to 15 carbon atoms, such as for example 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene;

(b) any copolymer obtained by copolymerization of one or more of the conjugated dienes mentioned above with one another or with one or more ethylenically unsaturated monomers.

By way of ethylenically unsaturated monomers, mention may be made of:
vinylaromatic compounds having from 8 to 20 carbon atoms, such as for example styrene, ortho-, meta- or para-methylstyrene, para-(tert-butyl)styrene, alpha-methylstyrene, the “vinyltoluene” commercial mixture, vinylmesitylene, divinylbenzene or vinylnaphthalene;
vinyl nitrile monomers having 3 to 12 carbon atoms, such as for example acrylonitrile or methacrylonitrile;
acrylic ester monomers derived from acrylic acid or methacrylic acid with alcohols having 1 to 12 carbon atoms, such as for example methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate.

The copolymers may contain between 99% and 20% by weight of diene units and between 1% and 80% by weight of vinylaromatic units, vinyl nitriles and/or acrylic esters.

(c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, especially, 1,4-hexadiene, vinylnorbornene, ethylidenenorbornene, norbornadiene or dicyclopentadiene;

(d) a copolymer of isobutene and of isoprene (butyl rubber) and also the halogenated versions, in particular chlorinated or brominated versions, of this type of copolymer;

(e) natural rubber;

(f) a copolymer of a conjugated diene monomer, selected from conjugated C₄ to C₈ diene monomers, and of an olefin/alpha-olefin-type monomer, selected from ethylene or C₃ to C₂₀ alpha olefins;

(g) a mixture of several of the elastomers defined in (a) to (f) with one another.

The diene elastomers which may be used according to the invention may be obtained according to conventional polymerization techniques well known to those skilled in the art, which depends on the nature, macrostructure and microstructure of the elastomer. The elastomers may have any microstructure, which depends on is the polymerization conditions used, especially on the presence or absence of a modifying and/or randomizing agent and on the amounts of modifying and/or randomizing agent employed. The elastomers may, for example, be block, random, sequential or microsequential elastomers and may be prepared in dispersion, in emulsion or in solution; they may be coupled and/or star-branched or else functionalized with a coupling and/or star-branching or functionalization agent.

Among the elastomers used within the context of the grafting method according to the invention, mention may be made, as non-exclusive examples, of polybutadiene, polyisoprene or polychloroprene and their hydrogenated versions, polyisobutylene, block copolymers of butadiene and isoprene with styrene and their hydrogenated versions, such as poly(styrene-b-butadiene) (SB), poly(styrene-b-butadiene-b-styrene) (SBS), poly(styrene-b-isoprene-b-styrene) (SIS), poly[styrene-b-(isoprene-stat-butadiene)-b-styrene] or poly(styrene-b -isoprene-b-butadiene-b-styrene) (SIBS), hydrogenated SBS (SEBS), poly(styrene -b-butadiene-b- methyl methacrylate) (SBM) and also its hydrogenated version (SEBM), random copolymers of butadiene with styrene (SBR) and acrylonitrile (NBR) and their hydrogenated versions, random copolymers of isoprene with styrene (SIR) and their hydrogenated versions, random copolymers of isoprene and butadiene with styrene (SBIR) and their hydrogenated versions, butyl or halogenated rubbers, ethylene-propylene-diene copolymers (EPDM), ethylene-diene copolymers and mixtures thereof.

Among these, the diene elastomer(s) used in the invention are most particularly selected from the group of diene elastomers consisting of polybutadienes (BR), synthetic polyisoprenes (IR), natural rubber (NR), butadiene copolymers, isoprene copolymers and the mixtures of these elastomers, Such copolymers are more preferentially selected from the group consisting of butadiene/styrene copolymers (SBR), isoprene/butadiene copolymers (BIR), isoprene/styrene copolymers (SIR), isoprene/butadiene/styrene copolymers (SBIR) and ethylene/butadiene copolymers (EBR) and mixtures thereof.

According to variants of the invention, the diene elastomer(s) used in the method of the invention are selected from the elastomers having a content by weight of units bearing a pendant unsaturation along the chain, especially of vinyl type (for example 1,2- and 3,4-type units), in the diene part, of greater than 20%, preferentially of at least 40% and more preferentially still of at least 50%.

According to an embodiment of the invention, the diene polymer bearing polyphosphorus-based grafts is obtained by carrying out the following steps:
a. bringing together, with stirring, at least one diene polymer in solution and at least one polyphosphorus-based polymer bearing a chain-end thiol function in solution,
b. heating the homogeneous reaction mixture obtained in the previous step to the grafting reaction temperature, and
c. adding the radical initiator concomitantly with either of steps a) and b) or preferably once the grafting reaction temperature has been reached.

The method according to an embodiment of the invention brings together at least one diene polymer in solution and at least one polyphosphorus-based polymer bearing a chain-end thiol function in solution. This implies prior dissolving of the various polymers in suitable solvents.

According to one implementation, the diene polymer, in particular the diene elastomer, is dissolved in a first solvent and mixed with stirring, preferably mechanical stirring, with the chain-end thiol-functionalized polyphosphorus-based polymer dissolved in a second solvent. Or, conversely, the chain-end thiol-functionalized polyphosphorus-based polymer dissolved in a solvent is mixed with stirring, preferably mechanical stirring, with the diene polymer, in particular the diene elastomer, dissolved in another solvent with stirring.

Thus, in step a), the reaction mixture comprises a solvent which consists of a mixture comprising at least one solvent for the diene polymer and at least one solvent for the polyphosphorus-based polymer. Preferably, the two solvents are miscible. According to one variant of the method according to the invention, the solvents are identical.

By way of solvent for the polyphosphorus-based polymer, use may be made of any polar solvent such as a ketone, a sulphoxide, a THF (tetrahydrofuran) or dioxane type ether, a halogenated solvent of chloroform, dichloromethane, dichloroethane, tetrachloroethane, 1,2-dichlorobenzene type, etc., and mixtures thereof. Preferably, 1,2-dichlorobenzene or THF are used.

By way of solvent for the diene elastomer, use may be made according to the method in accordance with the invention of any inert hydrocarbon-based solvent which may be for example an aliphatic or alicyclic hydrocarbon such as pentane, hexane, heptane, isooctane, cyclohexane or methyllcyclohexane, or an aromatic hydrocarbon such as benzene, toluene or xylene, and also mixtures thereof, or else a polar solvent of ether type such as THF or dioxane and the mixture thereof. Preferentially, methylcyclohexane, toluene or THF are used.

According to the variant according to which the solvents for the various polymers are identical, THF is preferably used.

A variant of the method of the invention consists in using a mixture of chain-end thiol-functionalized polyphosphorus-based polymers as defined above as molecules to be grafted onto the diene polymer.

The method comprises the step of heating the homogeneous reaction mixture obtained in the previous step to the grafting reaction temperature. The grafting reaction temperature is at least 20° C., preferably at least 50° C. and even more preferentially 60° C. The grafting reaction temperature is at most 120° C., preferably at most 100° C. and even more preferentially at most 90° C.

The method comprises the step of adding a radical initiator which, once the grafting reaction temperature has been reached, brings about the grafting of the chain-end thiol-functionalized polyphosphorus-based polymer to the polymer units comprising unsaturations.

By way of radical initiator, use may be made according to the invention of any initiator known to those skilled in the art. For example, mention may be made of azobisisobutyronitrile or else, generally, peroxides such as lauroyl peroxide or peroxypivalate. Some or all of the radical initiator may be added to the reaction mixture at any moment in steps a) or b) or else once the grafting temperature has been reached. Adding the radical initiator after heating the medium, once the grafting temperature has been reached, is a preferential variant of the method of the invention. The radical initiator may be added to the reaction mixture in any standard form; nonetheless, it is preferably added in the form of a solution in a solvent. Preferably, the solvent for the radical initiator is identical to at least one of the polar and apolar solvents used to dissolve the polymer to be grafted and the diene elastomer, respectively. By way of such a solvent, mention may thus be made of THF.

Preferably, the molar ratio of the thiol-terminated polyphosphorus-based polymer to the radical initiator is at least 5, preferentially at least 10, or even at least 45, and is at most 100, preferentially at most 60. More preferentially still, the molar ratio of the thiol-terminated polyphosphorus-based polymer to the radical initiator is at least 45 and at most 55.

Preferably, the amount of total solvent, or of solvent of the reaction medium, is such that the concentration by weight of elastomer is between 1 and 50%, preferably between 2 and 20% and even more preferentially between 3 and 10% in said solvent.

The grafting reaction proceeds according to a thiol-ene reaction mechanism known to those skilled in the art, i.e. a hydrothiolation of a carbon-carbon double bond.

It is suitable to note that, in the context of the invention, the variants and preferential aspects described above may be combined with one another.

At the end of this grafting reaction, a certain percentage of double bonds borne by the diene polymer have been consumed by the reaction, essentially the pendant double bonds along the chain, especially the double bonds of vinyl origin. The finished polymer is characterized by its molar fraction of phosphorus-based functions which is itself linked to the molar fraction of polyphosphorus-based grafts and also to the degree of polymerization of the polyphosphorus-based graft.

Those skilled in the art will understand that it is not possible to put a specific number on this molar content of phosphorus-based functions, as it may vary for one and the same elastomer or one and the same diene part within a range which is limited to a low value at a low degree of grafting by polyphosphorus-based polymers having a low proportion of phosphorus-based units, at least two, and to a high value at a 100% degree of grafting by polyphosphorus-based polymers having a high proportion of phosphorus-based units m, m preferably being at most 500.

The radical grafting method according to the invention may be carried out continuously or batchwise. Those skilled in the art will understand that, as a function of how it is carried out, the steps of the method, especially steps a), b) and c), therefore occur simultaneously or successively.

At the end of the grafting, the reaction is stopped in a conventional way known to those skilled in the art, for example by adding an antioxidant such as 4,4′-methylenebis(2,6-(tert-butyl)phenol) or any other suitable agent to the grafted elastomer obtained. This antioxidant may be added in the form of a solution in an organic solvent, such as toluene or methylcyclohexane, which is then evaporated.

According to variants of the invention, according to which polyphosphorus-based polymers comprising phosphonate functions are grafted along the polymer chain, at the end of the grafting reaction all or some of the phosphonate functions may advantageously be transformed, by methods known to those skilled in the art, into phosphonic acid functions (for example by reacting with TMSBr/MeOH) or into phosphonic hemiacid functions (for example by reacting with sodium iodide NaI).

Another subject of the invention is the grafted diene polymer bearing polyphosphorus-based grafts along the chain which is able to be synthesized by the method described above.

The grafted diene polymer comprises a main chain derived from the diene polymer and side chains, or grafts, derived from the thiol-terminated polyphosphorus-based polymer.

According to some variants, the grafted diene polymer corresponds to the formula (III):

P[-G]ᵢ (III)
in which:
P represents the polymer chain derived from the diene polymer,
G represents the polyphosphorus-based graft derived from the thiol-terminated polyphosphorus-based polymer of formula I described above, and
i represents the number of grafted units.

P represents the polymer chain derived from the diene polymer. The latter is as described above, encompassing all its variants.

G represents the polyphosphorus-based graft derived from the thiol-terminated polyphosphorus-based polymer described above, G comprises the sulphur atom which links it to the polymer. According to variants, G encompasses all the variant definitions of formula I relating to R and the monomer units from which the polyphosphorus-based polymer is derived,

i represents the number of grafted units. It is a number at least equal to 1. According to one variant of the invention, i is at most equal to 10 000 in one and the same molecule of grafted polymer.

The polymer according to the invention has the special feature of being able to contain a high content of phosphorus-based functions. Indeed, the molar fraction of phosphorus-based functions depends on the molar fraction of polyphosphorus-based grafts and on the degree of polymerization of the polyphosphorus-based part of the graft.

According to variants of the invention, the degree of polymerization of the polyphosphorus-based part of the graft ranges from 2 to 500.

The molar fraction of polyphosphorus-based grafts, for its part, is dependent on the yield of the grafting reaction and on the content of unsaturations.

According to variants of the invention, the molar content of polyphosphorus-based grafts relative to the diene part of the diene polymer is at least 0.05%, preferably 0.2% and even more preferentially 0.3%, and it is at most 30%, preferably 15% and even more preferentially 10%.

The diene polymers bearing polyphosphorus-based grafts according to the invention may be used as is, or in mixtures with one or more other compounds. The presence of phosphonate or phosphonic groups along the chain makes it possible to envisage use in applications similar to those for modified diene polymers in general, and polymers bearing phosphonate or phosphonic functions in particular.

For example, it is known practice, to optimize interactions between the elastomer and the reinforcing filler within a reinforced rubber composition, to modify the nature of the diene polymers in order to introduce functional groups therein. Thus, the specific structure of the grafted polymer according to the invention makes it possible to envisage the use thereof in the manufacture of various products based on reinforced rubber.

Another subject of the invention is therefore a rubber composition comprising a reinforcing filler and an elastomer as described above or prepared by radical grafting according to the method described above.

The rubber composition has the feature of comprising a reinforcing filler, for example carbon black, an inorganic reinforcing filler such as silica, with which a coupling agent is combined in a known way, or else a mixture of these two types of filler.

According to one advantageous variant of the invention, the reinforcing filler is predominantly other than carbon black, that is to say that it preferentially comprises more than 50% by weight, of the total weight of the filler, of one or more fillers other than carbon black, especially an inorganic reinforcing filler such as silica, or even exclusively consists of such a filler. According to this variant, when carbon black is also present, it may be used at a content of less than 20 phr, more preferentially less than 10 phr (for example between 0.5 and 20 phr, especially between 2 and 10 phr).

Preferentially, the content of total reinforcing filler (carbon black and/or other reinforcing filler such as silica) is between 10 and 200 phr, more preferentially between 30 and 150 phr, the optimum being, in a known way, different according to the specific applications targeted.

Another feature of the rubber composition in accordance with the invention is that it comprises the grafted diene polymer bearing polyphosphorus-based grafts. According to variants of the invention, the composition may comprise, in addition to this grafted polymer, at least one customary diene elastomer. This or these diene elastomer(s) are thus present in the elastomer matrix in proportions of between 0 and 60 phr (the limit values of this range being excluded), preferentially at most 50 phr, and even more preferentially at most 30 phr. In the case of a blend with at least one customary diene elastomer, the fraction by weight of the grafted diene polymer in the elastomer matrix is predominant and is preferably more than 40 phr; more preferentially still this content is at least 50 phr, in particular at least 70 phr.

As customary diene elastomer, polybutadienes (BR), butadiene copolymers, polyisoprenes (PI), isoprene copolymers and mixtures of these elastomers are more particularly suitable. Such copolymers are more preferentially selected from the group consisting of copolymers of butadiene and of a vinylaromatic monomer, more particularly the butadiene/styrene copolymer (SBR) or isoprene/butadiene to copolymers (BIR), copolymers of isoprene and of a vinylaromatic monomer, more particularly the isoprene/styrene copolymer (SIR) and isoprene/butadiene/styrene copolymers (SBIR).

According to variants of the invention, the customary diene elastomer may be star-branched, coupled, functionalized or non-functionalized, in a manner known per se by means of functionalization agents, coupling agents or star-branching agents known to those skilled in the art.

The rubber compositions in accordance with the invention may also comprise all or some of the standard additives customarily used in elastomer compositions intended for the manufacture of tyres, such as, for example, pigments, protective agents, such as antiozone waxes, chemical antiozonants or antioxidants, antifatigue agents, reinforcing or plasticizing resins, methylene acceptors (for example, phenolic novolak resin) or methylene donors (for example, HMT or H3M), as described, for example, in application WO 02/10269, a crosslinking system based either on sulphur or on sulphur donors and/or on peroxides and/or on bismaleimides, vulcanization accelerators, vulcanization activators, adhesion promoters, such as cobalt-based compounds, plasticizing agents, preferably non-aromatic or very slightly aromatic plasticizing agents selected from the group consisting of naphthenic oils, paraffinic oils, MES oils, TDAE oils, ether plasticizers, ester plasticizers, hydrocarbon-based resins exhibiting a high Tg, preferably of greater than 30° C., as described, for example, in applications WO 2005/087859, WO 2006/061064 and WO 2007/017060, and the mixtures of such compounds.

The use of such a rubber composition is particularly suitable in the field of tyres, especially for vehicles. This is why a tyre, one of the constituent elements of which comprises a rubber composition based on a grafted diene polymer described above in terms of its structure or its mode of synthesis, is also a subject of the invention.

The abovementioned features of the present invention, and also others, will be better understood on reading the following description of several exemplary embodiments of the invention, given by way of non-limiting illustration,

### EXAMPLES

### Measurements Used

The elastomers are characterized before curing, as indicated below.

Size Exclusion Chromatography

The number-average molar masses Mn of the polymers, and also their dispersities, were obtained by size exclusion chromatography (SEC) with tetrahydrofuran (THF) as eluent at 1 ml/min. Calibration is carried out with polystyrene standards (PS) having molar masses of between 1200 and 512 800 g mol⁻¹. The SEC chain is equipped with an RI Waters 2414 detector and a set of 2 columns (Shodex KF-802.5 and KF-804) thermostatically controlled at 35° C.

Glass Transition Temperature

The analyses for determining the glass transition temperature were carried out with a Netzsch DSC apparatus (Phoenix).

An aluminium crucible comprising 5 to 10 mg of sample is placed on a platinum boat. The rate of temperature rise used for all the samples is 10° C. min⁻¹. The analyses were carried out under nitrogen.

Nuclear Magnetic Resonance Spectroscopy

¹H NMR, ³¹P NMR and ¹³C NMR analyses are recorded on a 300 MHz Bruker spectrometer at ambient temperature and using CDCl₃ as solvent. Chemical shifts are given in ppm. The monomer conversions are determined by ¹H NMR and ³¹P NMR.

### Example Embodiments of the Invention

### Example 1

### Synthesis of a Xanthate with C4 Cyanomethyl Function

### Reaction Scheme

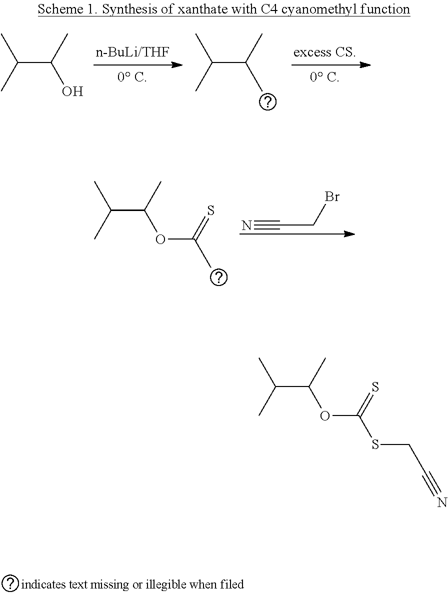

6 g (6.81×10⁻² mol) of 3-methylbutanol are dissolved in 45 ml of THF in a 500 ml round-bottomed flask. A solution of BuLi (1.6 M in hexane) (46.5 ml, 7.44×10⁻² mol) is added dropwise to the reaction mixture at 0° C. The reaction is left, with stirring, for 30 minutes. Carbon disulphide (30 ml, 4.96×10⁻¹ mol) is added dropwise to the reaction medium at 0° C. The reaction mixture is then maintained under magnetic stirring for 30 minutes at 0° C. 11.6 g (13.62×10⁻² mol) of bromoacetonitrile is added dropwise to the reaction mixture, then the solution is kept under stirring for 15 h. After evaporating the THF, the residue is purified by CH₂Cl₂ (1:1) extraction. The CH₂Cl₂ solution is evaporated under vacuum. After purification on a chromatography column (eluent: 95/5 petroleum ether/ethyl acetate) and evaporation, the product is obtained in the form of a yellowish oil with a final yield of 86%.

¹H NMR (300 MHz, CDCl₃, δ=ppm): 5.58 (1H, m, O—CHCH₃), 3.85 (2H, s, NC—CH₂—S—C═S), 2.02 (1H, m, (—CH(CH₃)₂), 1.33 (3H, d, O—CHCH₃), 0.96 (6H, d, (—CH(CH₃)₂).

¹³C NMR (300 MHz, CDCl₃, δ=ppm): 208.6 (S═CSCH—), 115.5 (NC—CH₂—S—C═S), 87.8 (O—CHCH₃), 32.7 ((—CH(CH₃)₂), 21.1 (NC—CH₂—S—C=S), 18.1 (—CH(CH₃)₂), 17.9 (O—CHCH₃), 15.8 (O—CHCH₃).

### Example 2

### Synthesis of the dimethyl vinylphosphonate DMVP-C4 Monoadduct

### Reaction Scheme

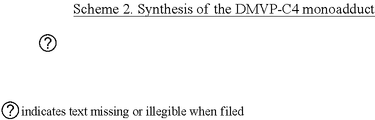

The C4 xanthate (2.76 g, 13.59×10⁻mol), the dimethyl vinylphosphonate (1 g, 7.35×10⁻³ mol) and the 1,2-dichloroethane solvent (6 ml) are introduced into a 25 ml round-bottomed flask surmounted by a condenser. The mixture is degassed under argon for 15 minutes. The reaction mixture is then maintained at the reflux point of the solvent (95° C.) and under magnetic stirring for 7 hours. 5 mol % of dilauroyl peroxide are added every 60 minutes up to 25 mol %. After purification on a chromatography column (eluent: ethyl acetate) and evaporation, the final yield of the synthesis is 65%.

¹H NMR (300 MHz, CDCl₃, δ=ppm): 5.58 (1H, m, O—CHCH₃), 4.35 (1H, m, NC—CH₂—CH₂—CH₁—S—C═S), 3.82 (3H, s, P═(OCH₃)₂), 2.62 (2H, m, NC—CH₂—CH₂—CH₁—S—C═S), 2.45-2.21 (2H, m, NC—CH₂—CH₂—CH₁—S—C═S,), 2.03 (—CH(CH₃)₂), 1.35 (3H, d, O—CHCH₃), 0.95 (6H, d, (—CH(CH₃)₂).

³¹P NMR (300 MHz, CDCl₃, δ=ppm): 24.6 (1P, d, P=(OCH₃)₂).

¹³C NMR (300 MHz, CDCl₃, δ=ppm): 210.7 (S═CSC—), 119.1 (NC—CH₂—CH₂—CH₁—S—C═S), 88.0 (O—CHCH₃), 54.2 (P═(OCH₃)₂), 44.4 and 42.6 (NC—CH₂—CH₂—CH₁—S—C═S), 32.7 ((—CH(CH₃)₂), 26.6 (NC—CH₂—CH₂—CH₁—S—C═S), 19.1 (—CH(CH₃)₂), 16.4 (O—CHCH₃), 15.1 (NC—CH₂—CH₂—CH₂—S—C═S),

### Example 3

### Aminolysis of the DMVP-C4 Monoadduct

### Reaction Scheme

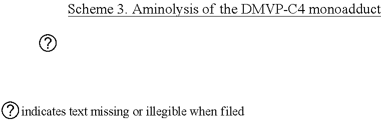

200 mg (2.94×10⁻⁴ mol) of DMVP-C4 monoadduct are dissolved in 6 ml of dichloromethane in a 25 ml round-bottomed flask. The round-bottomed flask is placed in an ice bath, degassed under argon for 15 minutes, then kept in darkness under an inert atmosphere until the monoadduct has completely dissolved. A second solution containing 1 ml of propylamine in 40 ml of dichloromethane is prepared then degassed under argon for 15 minutes. 1 ml (2.94×10⁻⁴ mol) of this stock solution is added dropwise at 0° C. to the reaction mixture containing the monoadduct. The reaction is left, with stirring, for 60 minutes. After purification on a chromatography column (eluent: ethyl acetate) and evaporation, the final yield of the aminolysis is 35%.

³¹P NMR (300 MHz, CDCl₃, δ=ppm): 26.3 (1P, s, P═(OCH₃)₂).

### Example 4

### Thermolysis of the DMVP-C4 Monoadduct

### Reaction Scheme

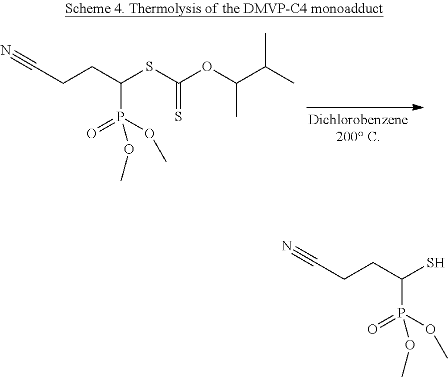 [SMILES: COP(=O)(OC)C(CCC#N)SC(=S)OC(C)C(C)C ; COP(=O)(OC)C(S)CCC#N]

The DMVP-C4 monoadduct (250 mg, 7.37×10⁻⁴ mol) and the 1,2-dichlorobenzene solvent (3 ml) are introduced into a 25 ml round-bottomed flask surmounted by a reflux condenser. The reaction mixture is degassed under argon for 15 minutes then maintained at the reflux point of the solvent (200° C.) in darkness for 5 minutes, The yield of the thermolysis is 70%, ³¹P NMR (300 MHz, CDCl₃, δ=ppm): 26.3 (1P, s, P═(OCH₃)₂).

### Example 5

### Synthesis of the PDMVP Oligomers

### Reaction Scheme

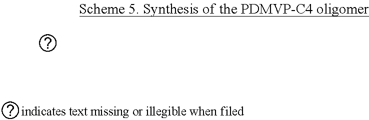

Polymerization is carried out according to the following protocol: the C4 xanthate (470 mg, 2.31×10⁻³ mol), the dimethyl vinylphosphonate (3 g, 2.2×10⁻² mol), the AIBN (72 mg, 4.38×10⁻⁴ mol) and 4.6 g of 1,4-dioxane are placed in a Schlenk tube. The solution is degassed under argon for 15 minutes then placed in a bath preheated to 70° C. The reaction is left, with stirring, for 24 hours. The reaction mixture is purified by drying under reduced pressure at 80° C. and by washing with dichloromethane to eliminate the residual monomer and the dioxane. The conversion obtained is 50% and the molar mass, determined by ³¹P NMR, is 720 g/mol (M_{n theo}=750 g/mol).

### Example 6

### Thermolysis of the PDMVP-C4 Oligomers

### Reaction Scheme

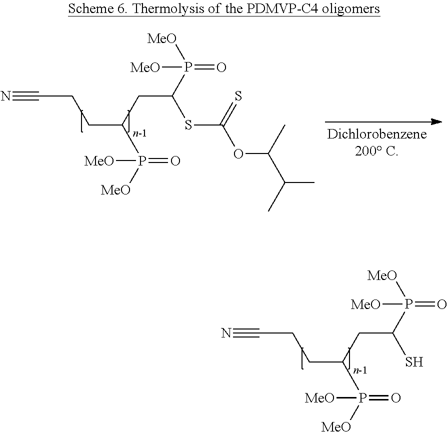

The PDMVP-C4 (250 mg, 3.47×10⁻⁴ mol) and the 12-dichlorobenzene solvent (3 ml) are introduced into a 25 ml round-bottomed flask surmounted by a condenser. The reaction mixture is degassed under argon for 15 minutes then maintained at the reflux point of the solvent (200° C.) in darkness for 15 minutes. The yield of the thermolysis is 72% (determined by ³¹P NMR).

### Example 7

### Thermolysis of the DMVP-C4 Monoadduct followed by Grafting to SBR

### Reaction Scheme

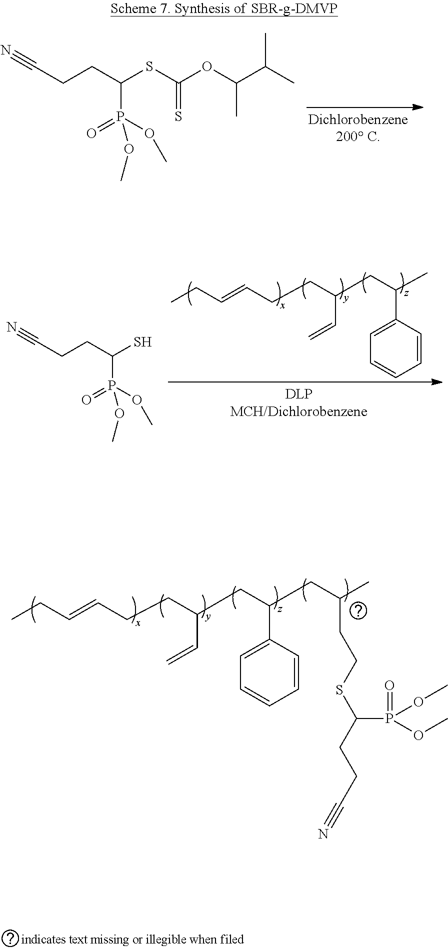

The DMVP-C4 monoadduct (250 mg, 7.37×10⁻⁴ mol) and the 1,2-dichlorobenzene solvent (3 ml) are introduced into a 50 ml round-bottomed flask surmounted by a reflux condenser. The mixture is degassed under argon for 15 minutes then maintained at the reflux point of the solvent (200° C.) in darkness for 5 minutes.

500 mg of SBR (Mₙ=235 900 g/mol, dispersity [symbol] (M_{w}/Mₙ)=1.24, 75% PB) are dissolved in 15 ml of methylcyclohexane. The latter SBR is already antioxidized with AO2246 (2,2′-methylenebis(4-methyl-6-tert-butylphenol)). This second solution is added to the monoadduct, then the reaction medium is degassed under argon for 15 minutes. The solution is then heated to 75° C. A solution of 10 mg of DLP in 20 ml of methylcyclohexane is prepared, then degassed under argon for 15 minutes. 1 ml (1.25×10⁻⁶ mol) of this stock solution is added via a syringe into the reaction medium. After 3 h of reaction, the mixture is cooled then precipitated out in methanol. The polymer is dissolved in dichloromethane then antioxidized with 1 ml of a 10 g/l solution of AO2246. The polymer is then dried under vacuum at 60° C. The grafting yield is 37.5% (determined by ¹H NMR),

Table 1 below summarizes the characteristics of the polymers synthesized by grafting the DMVP.

TABLE 1
Synthesis of SBR-g-DMVP by thiol-ene grafting. [SBR]₀ = 1.3 × 10⁻⁴ mol. I⁻¹, [DLP]₀ = 0.2%/[DMVP]₀,
T = 75° C., t = 3 h

| | | | | Exp. | % | | | | |
|---|---|---|---|---|---|---|---|---|---|
| | | % target | % exp. | graft | consumption | Molar fraction | Mn ^{b} | | |
| Example | [DMVP-C4]₀ | graft/ | graft/ | yield | of | phosphonate ^{a}/ | (g · mol⁻¹) | | Tg |
| 7 | mmol. I⁻¹ | unsaturations | unsaturations ^{a} | (%) ^{a} | unsaturations ^{a} | diene polymer | (PS) | [symbol] | (° C.) |
| Non- | 00 | 00 | 00 | 00 | 00 | 00 | 235 900 | 1.24 | −19.8 |
| grafted | | | | | | | | | |
| SBR | | | | | | | | | |
| SBR 7a | 6.3 | 1.36 | 0.925 | 68 | 2.95 | 3.6 | 250 800 | 1.23 | −21.1 |
| SBR 7b | 57.9 | 12.5 | 4.7 | 37.5 | 16.33 | 18.2 | 400 600 | 1.44 | −23.8 |

^{a} determination by ¹H NMR,
^{b} determination by SEC-RI in the THF with PS standards.

### Example 8

### Thermolysis of PDMVP-C4 followed by Grafting to SBR

### Reaction Scheme

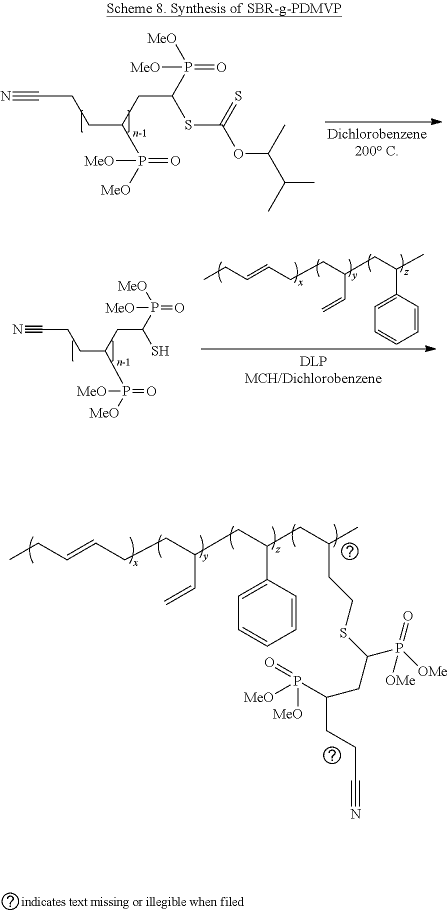

The PDMVP-C4 oligomer (250 mg, 3.47×10⁻⁴ mol) and the 1,2-dichlorobenzene solvent (3 ml) are introduced into a 50 ml round-bottomed flask surmounted by a condenser. The mixture is degassed under argon for 15 minutes then maintained at the reflux point of the solvent (200° C.) in darkness for 5 minutes. 500 mg of SBR (Mₙ=235 900 g/mol, [symbol] =1.24, 75% PB) are dissolved in 15 ml of methylcyclohexane. The latter SBR is already antioxidized with AO2246 (2,2′-methylenebis(4-methyl-6-tert-butylphenol)). This second solution is added to the PDMVP solution, then the reaction medium is degassed under argon for 15 minutes. The solution is then heated to 75° C. A solution of 10 mg of DLP in 20 ml of methylcyclohexane is prepared, then degassed under argon for 15 minutes. 1 ml (1.25×10⁻⁶ mol) of this stock solution is added via a syringe into the reaction medium. After 3 h of reaction, the mixture is cooled then precipitated out in methanol, The polymer is dissolved in dichloromethane then antioxidized with 1 ml of a 10 g/l solution of AO2246. The polymer is then dried under vacuum at 60° C. The grafting yield is 48.5% (determined by ¹H NMR).

Table 2 below summarizes the characteristics of the polymers synthesized by grafting the DMVP.

TABLE 2
Synthesis of SBR-g-PDMVP by thiol-ene grafting. [SBR]₀ = 1.3 × 10⁻⁴ mol. I⁻¹, [PDMVP-C4]₀ = 29.2 × 10⁻³ mol.
I⁻¹, [DLP]₀ = 0.2%/[PDMVP]₀, T = 75° C., t = 3 h.

| | | | | | % | | | | |
|---|---|---|---|---|---|---|---|---|---|
| | | % target | | | consumption | Molar fraction | Mn ^{b} | | |
| Example | [PDMVP-C4]₀ | graft/ | % exp. graft/ | Exp. graft | of | phosphonate a/ | (g mol⁻¹) | | Tg |
| 8 | mmol. I⁻¹ | unsaturations | unsaturations ^{a} | yield (%) ^{a} | unsaturations ^{a} | diene polymer | (PS) | [symbol] | (° C.) |
| Non- | 00 | 00 | 00 | 00 | 00 | 00 | 235 900 | 1.24 | −19.8 |
| grafted | | | | | | | | | |
| SBR | | | | | | | | | |
| SBR 8a | 3.7 | 1.05 | 0.7 | 66.5 | 2.2 | 12.2 | 239 800 | 1.25 | |
| SBR 8b | 23.1 | 6.6 | 3.2 | 48.5 | 8.1 | 55.8 | 243 000 | 1.26 | −34.1 |

^{a} determination by ¹H NMR,
^{b} determination by SEC-RI in the THF with PS standards.

Results

In comparison to the use of a thiol-terminated monophosphonate (example 7), grafting thiol-terminated polyphosphonates (example 8) makes it possible to obtain a phosphonate-modified diene polymer having high contents of phosphonate functions without actually having to target high degrees of grafting.

The use of small phosphonate-functional thiol molecules as described in example 7 has the drawback of changing the macrostructure in the case of high degrees of grafting.

In the case in which a low degree of grafting of the unsaturations of the diene elastomer is targeted, retention of the macrostructure of the final polymer is observed (entry 2, table 1 of example 7). However, in this case the molar fraction of the phosphonate functions in the final polymer is low (3.6%).

In order to obtain a diene polymer having high contents of phosphonate functions, a high degree of grafting of the unsaturations of the diene elastomer was targeted. The final polymer thus has a high molar fraction of phosphonate functions (18.2%). However, in this case the grafting reaction is accompanied by a change in the macrostructure, which is due to side reactions (bimolecular coupling, transfer reaction, etc.), the proportion of which increases with the targeted graft content. This is illustrated through the too high change in Mₙ (400 600 g·mol⁻¹), in dispersity ( [symbol] =1.44), and in the consumption of double bonds in the diene elastomer (table 1, entry 3 of example 7).

Advantageously, the use of a polyphosphorus-based polymer, in this instance polyphosphonate, bearing a chain-end thiol function, makes it possible to overcome the drawbacks linked to the use of small thiol-functionalized phosphonate molecules. This is because the use of polyphosphonate polymers makes it possible to obtain a modified diene polymer having a high molar content of phosphonate functions along the chain by targeting low degrees of grafting and without modifying the macrostructure of the final polymer.

This is illustrated in table 2, entry 2 of example 8. Indeed, it becomes possible to graft high molar contents of phosphonate functions (12.2%) without having to target a high content of the unsaturations of the diene elastomer. In this case, the grafting makes it possible to conserve the macrostructure of the final polymer (Mₙ=239 800 g·mol⁻¹, [symbol] =1.25).

It is also possible to increase the molar fraction of the phosphonate functions in the final diene polymer to achieve a very high content of 55.8% (table 2, entry 3 of example 8) without observing a change in the macrostructure of the final polymer (Mₙ=243 000 g·mol^{31 1}, [symbol] =1.26), which was not the case with the monophosphonate bearing the thiol function of example 7.

1. A method for the synthesis of a diene polymer bearing polyphosphorus-based grafts by radical grafting of a polyphosphorus-based polymer bearing a chain-end thiol function onto a diene polymer according to the following steps:
a. bringing together, with stirring, at least one diene polymer in solution and at least one polyphosphorus-based polymer bearing a chain-end thiol function in solution,
b. heating the homogeneous reaction mixture obtained in the previous step to the grafting reaction temperature, and
c. adding the radical initiator concomitantly with either of steps a) and b) or once the grafting reaction temperature has been reached.

2. The method according to claim 1, wherein the solvent for the polyphosphorus-based polymer bearing a chain-end thiol function is 1,2-dichlorobenzene or THF.

3. The method according to claim 1, wherein the solvent for the diene polymer is methylcyclohexane, toluene or THF.

4. The method according to claim 1, wherein the polyphosphorus-based polymer bearing a chain-end thiol function is represented by general formula I: 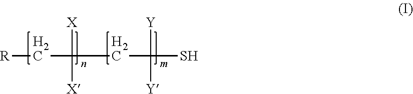
with
m denoting an integer greater than or equal to 1 and n denoting an integer greater than or equal to 0, with the proviso that, when n is other than 0, n and m may be identical or different.
R representing:
(i) an alkyl, acyl, aryl, alkenyl or alkynyl group,
(ii) a saturated or unsaturated, optionally aromatic carbon-based ring;
(iii) a saturated OF unsaturated, optionally aromatic heterocycle; or these groups and rings (i), (ii) and (iii) being able to be substituted by substituted phenyl groups, substituted aromatic groups, or alkoxycarbonyl or aryloxycarbonyl (—COOR′), carboxyl (—COOH), acyloxy (13 O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R′ representing an alkyl or aryl group,
(iv) a polymer chain,
X and X′, which are identical or different, representing a hydrogen atom, a halogen or an R₁, OR₁, OCOR_{I}, NHCOH, OH, NH₂, NHR₁, N(R₁)₂, (R₁)₂N⁺O⁻, NHCOR₁, CO₂H, CO₂R₁, CN, CONH₂, CONHR₁ or CON(R₁)₂ group, in which groups R₁ is selected from alkyl, aryl, aralkyl, alkylaryl, alkene or organosilyl groups which are optionally perfluorinated and optionally substituted by one or more carboxyl, epoxy, hydroxyl, alkoxy, amino, halogen or sulphonic groups,
Y and Y′, which are identical or different, being such that either Y or Y′, or both, comprise at least one phosphorus-based —P(O)(OR₂)(OR₃) function, in which R₂ and R₃, which are identical or different, represent a hydrogen atom or an alkyl, optionally haloalkyl, radical.

5. The method according to claim 4, wherein, in formula I, R is a cyanomethyl group of formula CNCH₂—, 1-phenylethyl group of formula CH₃(C₆H₅)CH— or methylpropionyl group of formula CH₃(CO₂CH₃)CH—.

6. The method according to claim 4, wherein the molar fraction of monomer units of the polyphosphorus-based polymer comprising X and X′ ranges from 0 to 0.5.

7. The method according to claim 1, wherein the polyphosphorus-based polymer bearing a chain-end thiol function has a number of units at least equal to 2 and at most equal to 1000.

8. The method according to claim 1, wherein the diene polymer is selected from the diene elastomers consisting of polybutadienes (BR), synthetic polyisoprenes (IR), natural rubber (NR), butadiene/styrene copolymers (SBR), isoprene/butadiene copolymers (BIR), isoprene/styrene copolymers (SIR), isoprene/butadiene/styrene copolymers (SBIR), ethylene/butadiene copolymers (EBR) and mixtures of these elastomers,

9. The method according to claim 1, wherein the diene polymer is selected from the elastomers having a content by weight of vinyl units in the diene part of greater than 20%.

10. The method according to claim 1, wherein the molar ratio of the polyphosphorus-based polymer hearing a chain-end thiol function to the radical initiator is at least 5 and is at most 100.

11. A diene polymer hearing polyphosphorus-based grafts consisting of a main polymer chain derived from a diene polymer which comprises units grafted by polyphosphorus-based grafts attached to said units via a sulphur atom.

12. The diene polymer bearing polyphosphorus-based grafts according to claim 11, wherein the main polymer chain is derived from an elastomer from among a polybutadiene (BR), a synthetic polyisoprene (IR), a natural rubber (NR), a butadiene and/or isoprene copolymer, especially a butadiene/styrene copolymer (SBR), an isoprene/butadiene copolymer (BIR), an isoprene/styrene copolymer (SIR), an isoprene/butadiene/styrene copolymer (SBIR), and ethylene/butadiene copolymers (EBR) and mixtures thereof.

13. The diene polymer bearing polyphosphorus-based grafts according to claim 11, wherein the polyphosphorus-based polymer chain of the graft corresponds to any homopolymer obtained by polymerization of a monomer bearing at least one phosphorus-based function or any copolymer of one or more monomers bearing at least one phosphorus-based function, with one another or with one or more comonomers.

14. The diene polymer bearing polyphosphorus-based grafts according to claim 11, corresponding to formula (III):
P[-G]ᵢ (III)
in which:
represents the polymer chain derived from the diene polymer,
G represents the polyphosphorus-based graft derived from the thiol-terminated polyphosphorus-based polymer of formula (I),
i represents the number of grafted units of the polymer chain derived from the diene polymer of general formula (I): 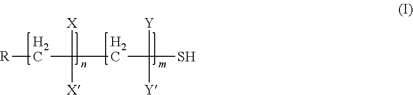
with
m denoting an integer greater than or equal to 2 and n denoting an integer greater than or equal to 0, with the proviso that, when n is other than 0, n and m may be identical or different.
R representing:
(i) an alkyl, acyl, aryl, alkenyl or alkynyl group,
(ii) a saturated or unsaturated, optionally aromatic carbon-based ring of a group (i);
(iii) a saturated OF unsaturated, optionally aromatic heterocycle; or these groups and rings (i), (ii) and (iii) being able to be substituted by substituted phenyl groups, substituted aromatic groups, or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO. PPO) or cationic substituents (quaternary ammonium salts), R representing an alkyl or aryl group,
(iv) a polymer chain,
X and X′, which are identical or different, representing a hydrogen atom, a halogen or an R₁, OR₁, OCOR₁, NHCOH, OH, NH₂, NHR₁, N(R₁)₂, (R₁)₂N⁺O^{31 1}, NHCOR₁, CO₂H, CO₂R₁, CN, CONH₂, CONHR₁ or CON(R₁)₂ group, in which groups R₁ is selected from alkyl, aryl, aralkyl, alkylaryl, alkene or organosilyl groups which are optionally perfluorinated and optionally substituted by one or more carboxyl, epoxy, hydroxyl, alkoxy, amino, halogen or sulphonic groups,
Y and Y′. which are identical or different, being such that either Y or Y′, or both, comprise at least one phosphorus-based —P(O)(OR₂)(OR₃) function, in which R₂ and R₃, which are identical or different, represent a hydrogen atom or an alkyl, optionally haloalkyl, radical.

15. The diene polymer bearing polyphosphorus-based grafts according to claim 11, wherein the polyphosphorus-based graft has a number of units at least equal to 2 and at most equal to 1000.

16. The diene polymer bearing polyphosphorus-based grafts according to claim 14, wherein the molar fraction of monomer units comprising X and X′, relative to the polymer chain derived from the polyphosphorus-based polymer, ranges from 0 to 0.5.

17. The diene polymer bearing polyphosphorus-based grafts according to claim 11, wherein the molar content of grafted polyphosphorus-based grafts relative to the diene part of the diene polymer is at least 0.05 and it is at most 30%.

18. The diene polymer bearing polyphosphorus-based grafts according to claim 11, wherein the diene polymer is obtained by the following steps:
a. bringing together, with stirring, at least one diene polymer in solution and at least one polyphosphorus-based polymer bearing a chain-end thiol function in solution.
b. heating the homogeneous reaction mixture obtained in the previous step to the grafting reaction temperature, and
c. adding the radical initiator concomitantly with either of steps a) and b) or once the grafting reaction temperature has been reached.

19. The diene polymer bearing polyphosphorus-based grafts according to claim 11, wherein the diene polymer is elastomeric.

20. A rubber composition based on at least one reinforcing filler and on at least one diene elastomer bearing polyphosphorus-based grafts as prepared according to the method defined in claim 1.

21. A tire comprising a rubber composition according to claim 20.

22. The method according to claim 4, wherein m and n are greater than 2 and less than 500.

23. The method according to claim 6, wherein the molar fraction ranges from 0 to 0.25.

24. The method according to claim 6, wherein the molar fraction is between 0 and 0.1.

25. The method according to claim 9, wherein the content by weight of vinyl units in the diene part is at least 40%.

26. The method according to claim 10, wherein the molar ratio of the polyphosphorus-based polymer bearing a chain-end thiol function to the radical initiator is at least 10 and at most 60.

27. The diene polymer bearing polyphosphorus-based grafts according to claim 14, wherein m and n are greater than 2 and less than 500.

28. The diene polymer bearing polyphosphorus-based grafts according to claim 16, wherein the molar fraction of monomer units comprising X and X′, relative to the polymer chain derived from the polyphosphorus-based polymer, ranges from 0 to 0.25.

29. The diene polymer bearing polyphosphorus-based grafts according to claim 16, wherein the molar fraction of monomer units comprising X and X′, relative to the polymer chain derived from the polyphosphorus-based polymer is between 0 and 0.1.

30. The diene polymer bearing polyphosphorus-based grafts according to claim 17 wherein the molar content of grafted polyphosphorus-based grafts relative to the diene part of the diene polymer is at least 0.2% and at most 15%.

31. A rubber composition based on at least one reinforcing filler and on at least one diene elastomer bearing polyphosphorus-based grafts as defined in claim 11.
